(19) United States
(12) Patent Application Publication
(10) Pub. No.: US 2026/0192859 A1
(43) Pub. Date: Jul. 9, 2026

(54) DEFLECTOR ASSEMBLY

(71) Applicant: Rivian IP Holdings, LLC, Irvine, CA (US)

(72) Inventors: Saurabh Shankar Shegokar, Santa Ana, CA (US); Matthew James Tummers, Huntington Beach, CA (US); Vinayak Kumar Varma, Irvine, CA (US)

(73) Assignee: Rivian IP Holdings, LLC, Irvine, CA (US)

(21) Appl. No.: 19/442,133

(22) Filed: Jan. 7, 2026

Related U.S. Application Data
(60) Provisional application No. 63/742,969, filed on Jan. 8, 2025.

(51) Int. Cl. B62D 21/15

(52) U.S. Cl. CPC B62D 21/15

(57) ABSTRACT

A deflector assembly for a vehicle can include a wheel block disposed behind a wheel in a front-rear direction of the vehicle. The wheel block can separate a first portion of the wheel from a second portion of the wheel responsive to a frontward force applied to the wheel. The deflector assembly can include a torque box disposed behind the wheel block in the front-rear direction of the vehicle. The torque box can laterally support a rocker disposed adjacent to the torque box responsive to the frontward force applied to the wheel.

### CROSS-REFERENCE TO RELATED PATENT APPLICATIONS

This application claims the benefit of and priority to U.S. Provisional Patent Application No. 63/742,969, filed on January 8, 2025, the entirety of which is incorporated by reference herein.

### INTRODUCTION

Vehicles can include a frame to provide structure for the vehicle.

### SUMMARY

The technical solutions are generally directed to an assembly including a wheel block and a torque box. The wheel block can facilitate initiating separation of a wheel of a vehicle responsive to a force applied by an object to the wheel of the vehicle. The wheel block can include a ramp section that can deform, pivot, or otherwise be configured to guide the wheel in a direction away from the vehicle responsive to the force applied by an object to the wheel of the vehicle. The torque box can be disposed behind the wheel block or adjacent to a rocker of the vehicle to support the wheel block and the rocker. The assembly can facilitate deflecting the vehicle responsive to the vehicle engaging with an object to reduce the amount of force or impact on the vehicle (e.g., on the rocker).

At least one aspect is directed to a deflector assembly. The deflector assembly can include a wheel block disposed behind a wheel in a front-rear direction of the vehicle. The wheel block can separate a first portion of the wheel from a second portion of the wheel responsive to a frontward force applied to the wheel. The deflector assembly can include a torque box disposed behind the wheel block in the front-rear direction of the vehicle. The torque box can laterally support a rocker disposed adjacent to the torque box responsive to the frontward force applied to the wheel.

At least one aspect is directed to a method. The method can include disposing a wheel block behind a wheel of a vehicle in a front-rear direction of the vehicle. The method can include separating, by a portion of the wheel block, a first portion of the wheel from a second portion of the wheel responsive to a frontward force applied to the wheel by the vehicle engaging with an object. The method can include guiding, by a second portion of the wheel block, the wheel away from a rocker. The method can include disposing a torque box behind the wheel block in the front-rear direction of the vehicle. The method can include laterally supporting, by the torque box, the rocker disposed adjacent to the torque box responsive to the frontward force applied to the wheel.

At least one aspect is directed to an electric vehicle. The electric vehicle can include a deflector assembly. The deflector assembly can include a wheel block disposed behind a wheel in a front-rear direction of the electric vehicle. The wheel block can separate a first portion of the wheel from a second portion of the wheel responsive to a frontward force applied to the wheel. The deflector assembly can include a torque box disposed behind the wheel block in the front-rear direction of the electric vehicle. The torque box can laterally support a rocker disposed adjacent to the torque box responsive to the frontward force applied to the wheel.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example top view of a vehicle, in accordance with some aspects.

FIG. 2 depicts an example front perspective view of a deflector assembly of the vehicle of FIG. 1, in accordance with some aspects.

FIG. 3 depicts an example front perspective view of a portion of the deflector assembly of FIG. 2, in accordance with some aspects.

FIG. 4 depicts an example front view of the portion of the deflector assembly of FIG. 3, in accordance with some aspects.

FIG. 5 depicts an example rear perspective view of the portion of the deflector assembly of FIG. 3, in accordance with some aspects.

FIG. 6 depicts an example top view of the portion of the deflector assembly of FIG. 3, in accordance with some aspects.

FIG. 7 depicts an example front perspective view of a portion of the deflector assembly of FIG. 2, in accordance with some aspects.

FIG. 8 depicts an example top view of the deflector assembly of FIG. 2 in a first state, in accordance with some aspects.

FIG. 9 depicts an example top view of the deflector assembly of FIG. 2 in a second state, in accordance with some aspects.

FIG. 10 depicts an example top view of the deflector assembly of FIG. 2 in a third state, in accordance with some aspects.

FIG. 11 depicts an example top view of the deflector assembly of FIG. 2 in a fourth state, in accordance with some aspects.

FIG. 12 depicts an example flowchart of a method of operating the deflector assembly of FIG. 2, in accordance with some aspects.

### DETAILED DESCRIPTION

Following below are more detailed descriptions of various concepts related to, and implementations of, methods, apparatuses, and systems of deflecting a vehicle from an object upon contact with the object by initiating separation of a wheel of the vehicle. The various concepts introduced above and discussed in greater detail below may be implemented in any of numerous ways.

This disclosure is generally directed to an assembly including a wheel block and a torque box. The wheel block can facilitate initiating separation of a wheel of a vehicle responsive to a force applied by an object to the wheel of the vehicle (e.g., during a small overlap load case (SORB)). The wheel block can include a ramp section that can deform, pivot, or otherwise be configured to guide the wheel in a direction away from the vehicle responsive to the force applied by an object to the wheel of the vehicle. The torque box can be disposed behind the wheel block or adjacent to a rocker of the vehicle to support the wheel block and the rocker. The assembly can facilitate deflecting the vehicle responsive to the vehicle engaging with an object to reduce the amount of force or impact on at least a portion of the vehicle (e.g., on the rocker or another portion of the frame of the vehicle).

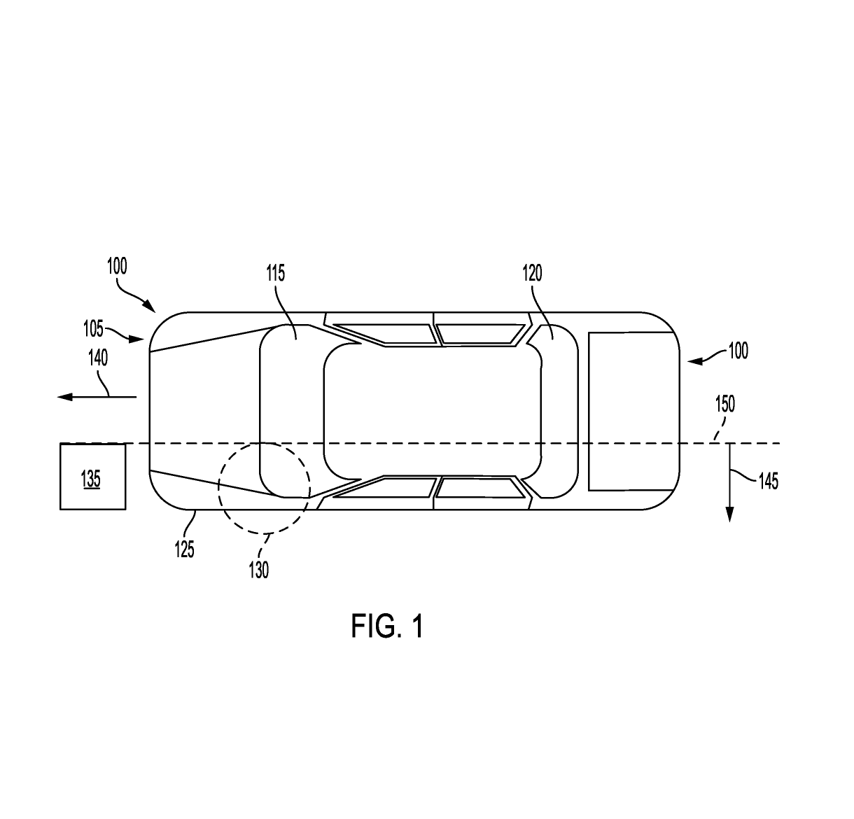

FIG. 1 depicts an example top view of a vehicle 100, in accordance with an example implementation. The vehicle 100 can include, but is not limited to, an automative vehicle including an electric vehicle. The vehicle 100 can extend between a front end 105 and a rear end 110. For example, the front end 105 of the vehicle 100 can include a front windshield 115 (e.g., where a driver of the vehicle 100 can look through) and the rear end 110 of the vehicle 100 can include a rear windshield 120. The vehicle 100 can include a frame 125. The frame 125 can be or can include various structures that support the vehicle 100. The frame 125 can be or can include a body-on-frame, a monocoque, a skateboard, or another type of frame. The frame 125 can include one or more longitudinal members (e.g., rails), cross members, mounting points, or other components. As described herein, the frame 125 can include a rocker, a beam, or one or more additional components that define and support the frame of the vehicle 100.

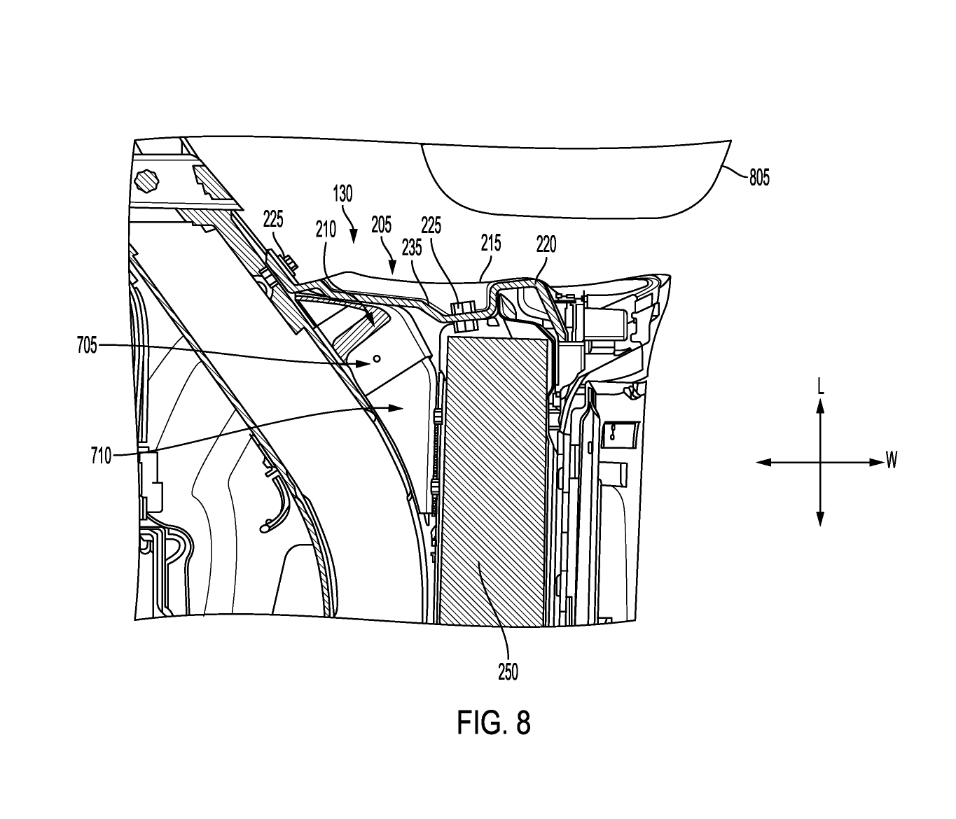

The vehicle 100 (e.g., a portion of the frame 125) can include a deflector assembly 130. The vehicle 100 can include a plurality of deflector assemblies 130. For example, the vehicle 100 can include a deflector assembly 130 disposed behind a wheel of the vehicle 100 (e.g., wheel 805 depicted in FIG. 8). For example, the deflector assembly 130 can be disposed at a rear-side of the wheel 805 of the vehicle 100 (e.g., such that the deflector assembly 130 is disposed closer to the second end 110 than the first end 105 of the wheel). The wheel 805 can include several components including a rim, a hub, and spokes, as described herein. The vehicle 100 can include a deflector assembly 130 behind each wheel 805 on the vehicle 100 (e.g., such that the vehicle 100 includes at least two deflector assemblies 130). For example, the vehicle 100 can include a first deflector assembly 130 disposed behind a first wheel 805, a second deflector assembly 130 disposed behind a second wheel 805, a third deflector assembly 130 disposed behind a third wheel 805, or a fourth deflector assembly 130 disposed behind a fourth wheel 805.

The vehicle 100 can experience various forces applied to the vehicle 100. For example, the vehicle 100 can engage with an object 135. The object 135 can include any object including, but not limited to, an obstacle such as a wall, pole, tree, or barrier. A portion of the front end 105 of the vehicle 100 can engage the object 135. For example, a section (e.g., defined by section outline 150 through the edge of the vehicle 100 in the direction of arrow 145) of the front end 110 can engage the object 135 when the vehicle 100 travels in a forward direction, as shown by arrow 140. This engagement can include, for example, a small overlap load case. The section defined by section outline 150 can include, for example about 25% overlap of the front end 105 of the vehicle 100.

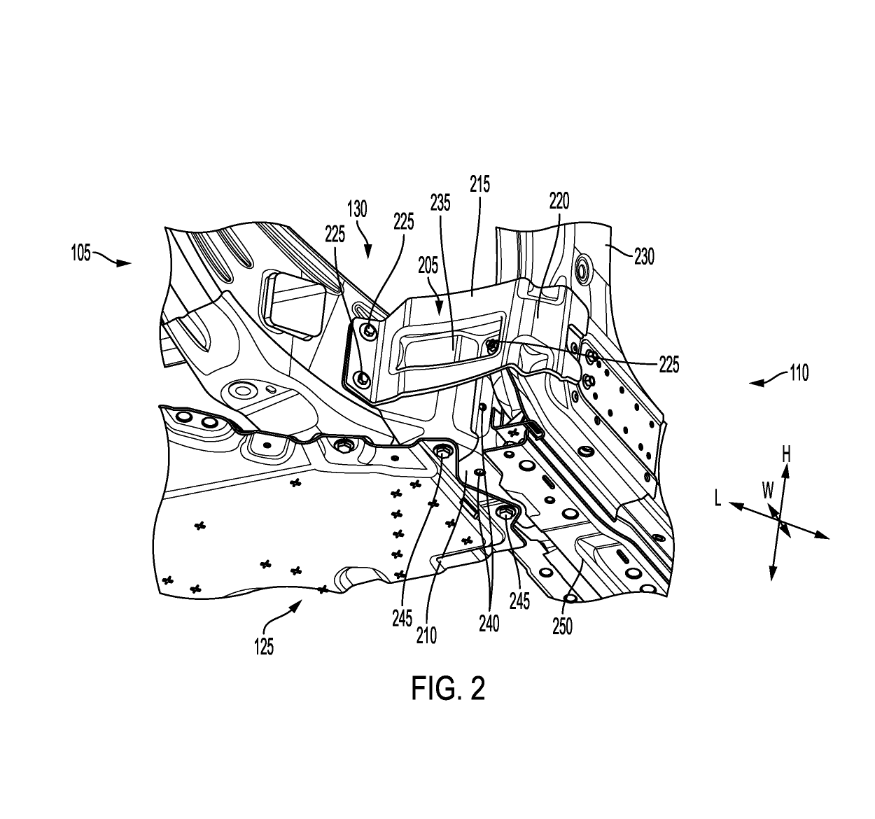

FIG. 2 depicts a front perspective view of a portion of the vehicle 100. For example, FIG. 2 depicts a front perspective view of the deflector assembly 130. The deflector assembly 130 can include a wheel block 205. The wheel block 205 can include a unitary (e.g., monolithic) structure, or one or more pieces, having one or more regions that can couple with the frame 125 of the vehicle 100. For example, the wheel block 205 can include at least one ramp portion 215. The ramp portion 215 can include at least one material that extends lengthwise across the wheel block 205. The ramp portion 215, as described herein, can facilitate guiding at least a portion of a wheel of the vehicle 100 in a direction away from a center of the vehicle 100 responsive to, for example, the front portion of the vehicle 100 engaging with the object 135. The wheel block 205 can include at least one wheel splitting portion 220. The wheel splitting portion 220 can include at least one protrusion, extension, or other portion of the wheel block 205. The wheel splitting portion 220, as described herein, can facilitate separating at least a portion of the wheel of the vehicle 100 apart responsive to, for example, the front portion of the vehicle 100 engaging with the object 135. The wheel block 205 can include at least one groove portion 235. The groove portion 235 can define various portions of the wheel block 205 (e.g., the ramp portion 215). For example, the groove portion 235 can include one or more recesses or other deformations within one or more surfaces of the wheel block 205.

The deflector assembly 130 can include a torque box 210. The torque box 210 can be disposed immediately behind the wheel block 205 in at least one direction of the vehicle 100. For example, the torque box 210 can be disposed behind the wheel block 205 in a front-rear direction of the vehicle 100 (e.g., direction L that extends from the front end 105 of the vehicle 100 to the rear end 110 of the vehicle 100). The torque box 210 can contact the wheel block 205, as described herein.

The wheel block 205 and the torque box 210 can couple with the vehicle 100 (e.g., via the frame 125). For example, the wheel block 205 can couple with the frame 125 through one or more fasteners 225. The deflector assembly 130 can include, for example, three fasteners 225. The torque box 210 can couple with the frame 125 through one or more fasteners 245. The wheel block 205 can couple with the torque box 210. For example, at least one of the fasteners 225 can couple with both the wheel block 205 and the torque box 210, as described herein. The torque box 210 can include one or more apertures 240. The one or more apertures 240 can receive a fastener, or the one or more apertures 240 may not receive a fastener.

The vehicle 100 (e.g., the frame 125) can include at least one beam 230. The vehicle 100 (e.g., the frame 125) can include at least one rocker 250 (e.g., rocker panel). The rocker 250 can be disposed behind (e.g., immediately behind) the torque box 210. For example, the rocker 250 can be disposed behind the torque box 210 in a front-rear direction of the vehicle 100 (e.g., direction L that extends from the front end 105 of the vehicle 100 to the rear end 110 of the vehicle 100). The rocker 250 can contact the torque box 210, as described herein. The wheel block 205 can couple with the beam 230 or the rocker 250 through at least one fastener 225. The rocker 250 can include a panel or beam that supports one or more portions of the vehicle 100, including, but not limited to, connecting the wheels of the vehicle, supporting the floor or doors of the vehicle, etc.

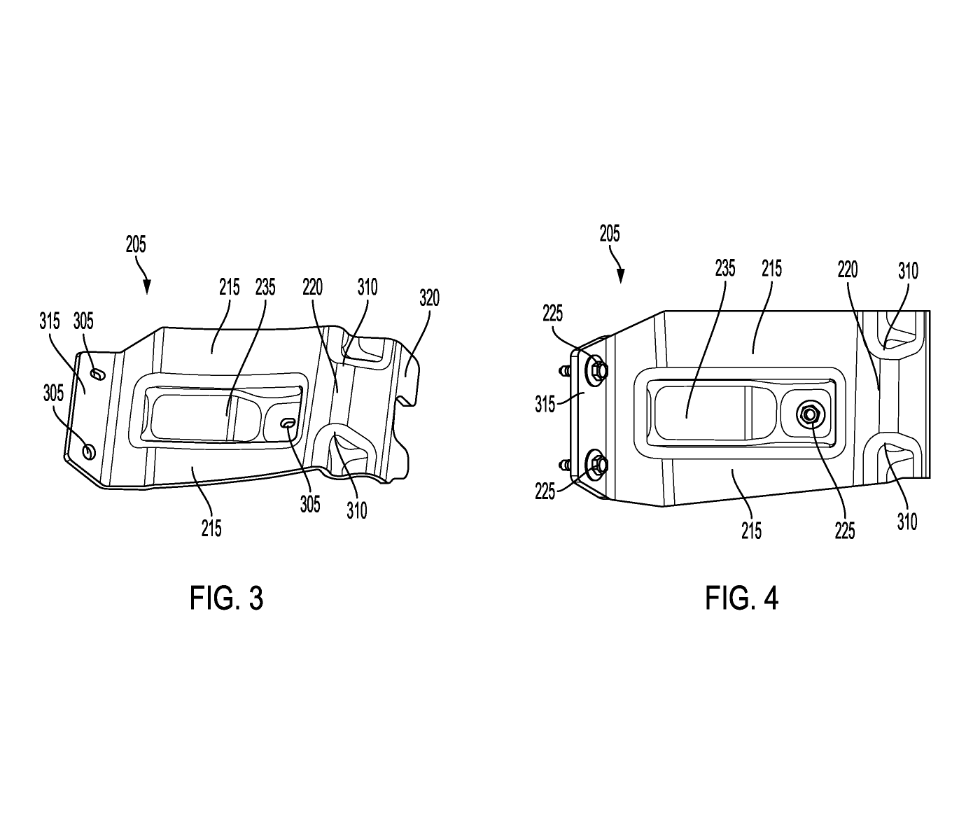

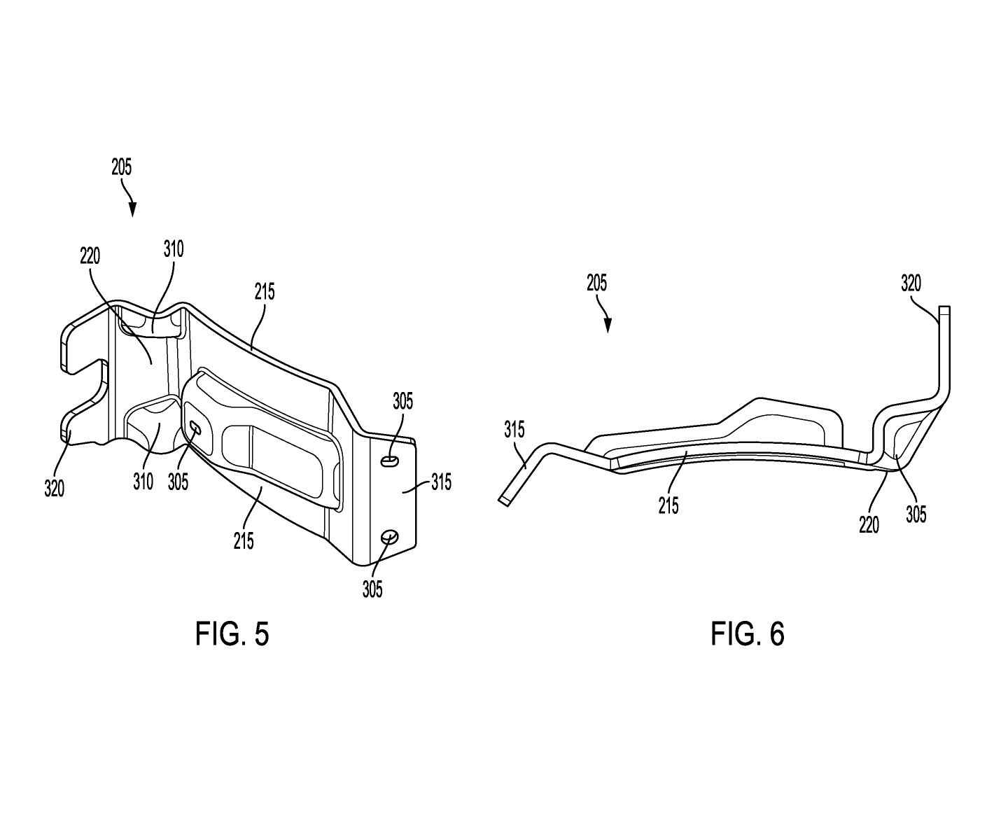

FIG. 3 depicts an example front perspective view of the wheel block 205 and FIG. 4 depicts an example front view of the wheel block 205. FIG. 5 depicts an example rear perspective view of the wheel block 205 and FIG. 6 depicts an example top view of the wheel block 205. As depicted in at least FIGS. 2-6, the wheel block 205 can include a single, unitary structure, or the wheel block 205 can include one or more separate pieces connected together. The wheel block 205 can include at least one ramp portion 215. For example, the wheel block 205 can include a top ramp portion 215 and a bottom ramp portion 215 separated by the groove portion 235. The ramp portion 215 can be or can include an at least partially curved or angled surface of the wheel block 205. As described herein, the ramp portion 215 can facilitate guiding a wheel away from the vehicle 100 responsive to the vehicle 100 engaging with the object 135 (e.g., guiding a wheel away from a center portion of the vehicle 100).

The wheel block 205 can include at least one wheel splitting portion 220. The wheel splitting portion 220 can include or can be, for example, a protrusion having at least one fillet 310 (e.g., a sharp or rounded corner) on the sides of the protrusion. For example, the wheel splitting portion 220 can include two fillets 310 defining a protrusion. The wheel splitting portion 220 can include at least one portion 320 that protrudes away from the ramp portion 215 at an angle (e.g., substantially perpendicular, or in a range of 5 degrees to 175 degrees). For example, the angled portion 320 can facilitate defining the wheel splitting portion 220.

The wheel splitting portion 220 (e.g., the protrusion defined by the one or more fillets 310) can provide a sharp feature that can pierce through or cause separation of a portion of the wheel 805 of the vehicle 100. For example, as described in greater detail herein, the wheel splitting portion 220 can engage with the wheel 805 at a location of the wheel 805 such that the wheel splitting portion 220 (e.g., at the fillets 310) separates at least one spoke (or other portion) of the wheel 805 from another portion of the wheel 805, such as a rim of a rubber tire. The shape of the wheel splitting portion 220 (e.g., the angled portion 320) alone or in combination with the angle of the ramp portion 215 of the wheel block 205 can cause the separated portion of the wheel 805 (e.g., the spoke) to move in a direction away from the vehicle 100 to facilitate reducing a load force on, for example, the rocker 250. The one or more fillets 310 can vary in size or shape. For example, the wheel splitting portion 220 can include two opposing fillets 310 to form the wheel splitting portion 220.

The wheel block 205 can include at least one aperture 305. The one or more apertures 305 can receive the one or more fasteners 225 to couple the wheel block 205 with a portion of the vehicle 100. The wheel block 205 can include three apertures 305 to respectively receive the three fasteners 225. The 3-point attachment scheme can facilitate allowing for a robust assembly and repeatability. For example, the wheel block 205 can include at least one flange 315. The flange 315 can protrude from the ramp portion 215 at a side of the wheel block 205 that opposes the wheel splitting portion 220. The flange 315 can include at least one aperture 305 to receive a fastener 225. The flange 315 can include two (or more) apertures 305 to receive two (or more) fasteners 225.

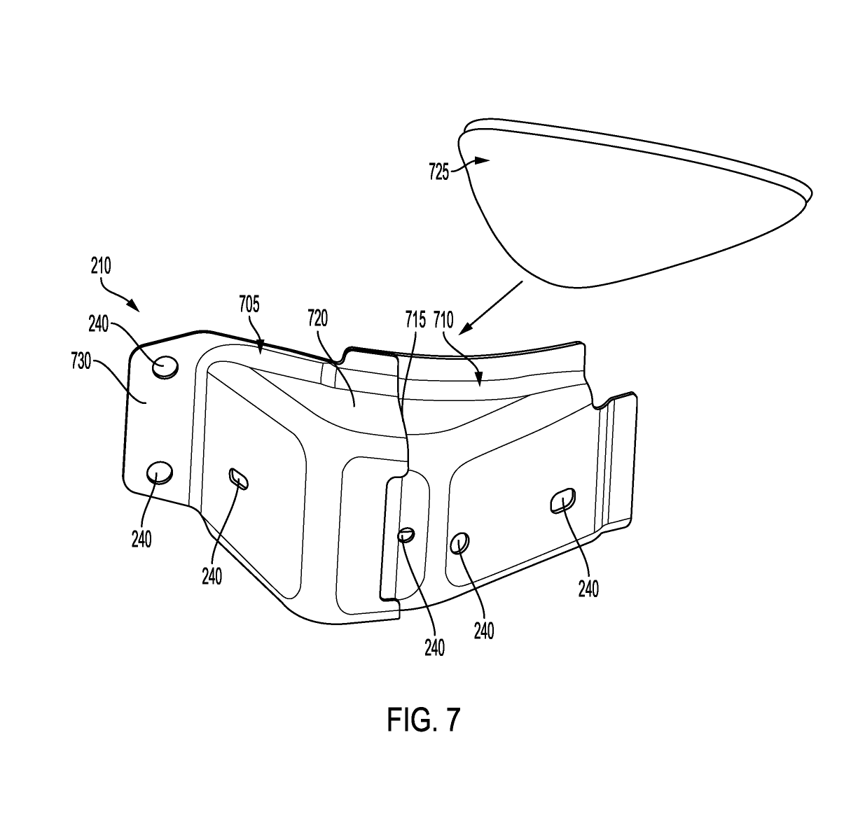

FIG. 7 depicts an example front perspective view of the torque box 210. The torque box 210 can include one, unitary piece. The torque box 210 can include two separate pieces coupled together. For example, the torque box 210 can include a first piece 705 and a second piece 710. The first piece 705 can couple with the second piece 710 in various ways. For example, the first piece 705 can couple with the second piece 710 by one or more welds, molds, adhesives, fasteners, or other ways (e.g., at seam 715). The torque box 210 can define a shell having at least one hollow space. For example, one or more of the first piece 705 or the second piece 710 can curve to create an outer fillet 720. An opposing side of the outer fillet 720 can be at least partially hollow. For example, the torque box 210 can define a boomerang-like shape (e.g., a rounded “L” shape).

The hollow portion of the torque box 210 that opposes the outer fillet 720 can receive one or more inserts 725. For example, the torque box 210 can at least partially receive a nylon insert 725. The insert 725 can include an exterior profile that at least partially matches an interior profile of the torque box 210. The nylon insert 725 can facilitate reinforcing the torque box 210 to strengthen the torque box 210. For example, the insert 725 can fit within the hollow portion of the torque box 210 to provide support for the torque box 210 when a force is applied to the opposing side of the torque box 210.

The torque box 210 can include at least one flange 730. The flange 730 can protrude from the first piece 705 of the torque box 210 (or from the second piece 710). The flange 730 can include at least one aperture 240 to receive a fastener 225, 245. The flange 730 can include two (or more) apertures 240 to receive two (or more) fasteners 225, 245. For example, the flange 730 of the torque box 210 can align with the flange 315 of the wheel block 205 such that a fastener 225 that extends through the wheel block 205 can also extend through the torque box 210 to couple the wheel block 205 with the torque box 210 and with the vehicle 100 (e.g., the frame 125). Additionally, or alternatively, multiple fasteners 225 can extend through the wheel block 205 and the torque box to couple the wheel block 205 with the torque box 210 and with the vehicle 100 (e.g., the frame 125).

The wheel block 205 and the torque box 210 can include various types of materials. For example, the wheel block 205 can include at least one metal material including, but not limited to, steel, aluminum, copper, titanium, nickel, magnesium, another metal, an alloy of any of these metals or other metals, or any combination thereof. The torque box 210 can include at least one metal material including, but not limited to, steel, aluminum, copper, titanium, nickel, magnesium, another metal, an alloy of any of these metals or other metals, or any combination thereof. The first piece 705 and the second piece 710 of the torque box 210 can include the same materials, or the first piece 705 and the second piece 710 can differ in materials (e.g., one is made of steel, another is made from a steel allow, or various other combinations).

FIG. 8 depicts an example top view of the deflector assembly 130 in a first state. For example, in this state, the deflector assembly 130 can couple with the vehicle 100 (e.g., via fasteners 225, or via other means). In this state, the vehicle 100 can be in motion or stationary. The vehicle 100 can be disposed away from, and not engaging with (e.g., contacting) the object 135. In this state, a wheel 805 of the vehicle 100 (e.g., a wheel disposed in front of the defector assembly 130, such as a front right or left side wheel) can be in a normal position (e.g., coupled with the vehicle 100 and capable of rolling without significant deformation). As depicted in at least FIG. 8, in this state, the wheel 805 is disposed in front of (e.g., in the front-rear direction L) the wheel block 205. The wheel block 205 is disposed in front of the torque box 210 and the rocker 250. The torque box 210 can be positioned immediately adjacent to (e.g., and contacting) the rocker 250 in a side-side direction (e.g., W direction).

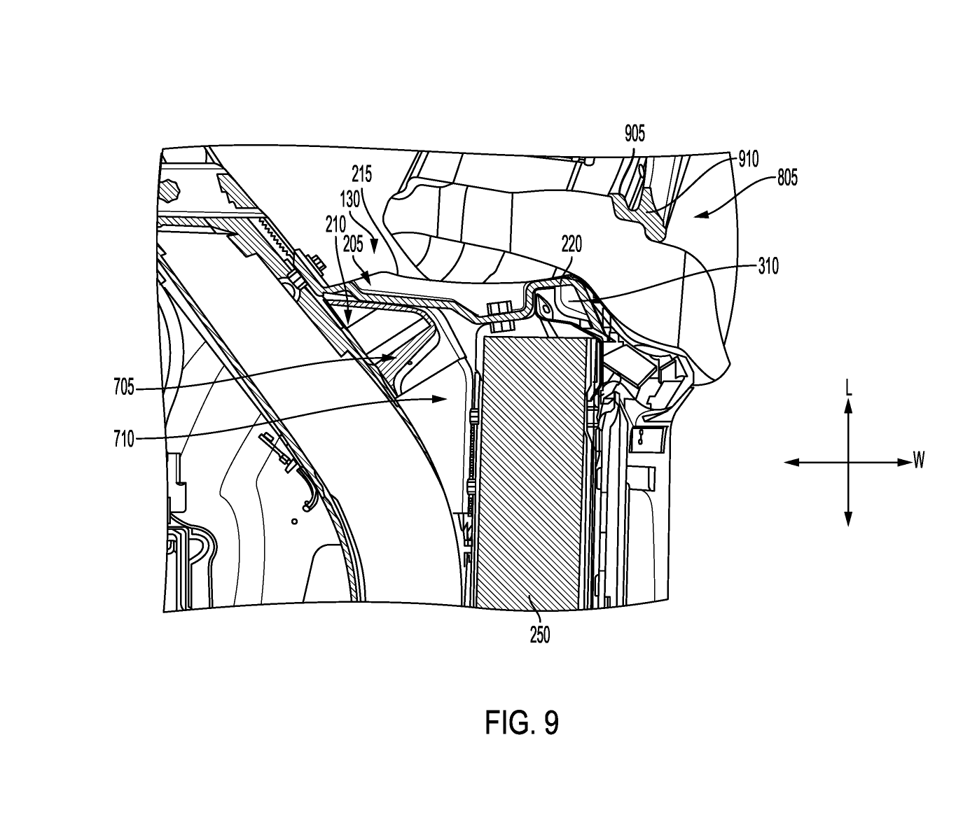

FIG. 9 depicts an example top view of the deflector assembly 130 in a second state. For example, in this state, the deflector assembly 130 can couple with the vehicle 100 (e.g., via fasteners 225, or via other means). In this state, the vehicle 100 can be in motion or stationary. The vehicle 100 can be engaging with (e.g., contacting) the object 135. For example, this state can depict a moment at which the front end 105 of the vehicle 100 immediately or initially contacts the object 135 (e.g., around 0 seconds or more) such that the wheel 805 of the vehicle 100 beings to deform responsive to the wheel 805 engaging with the object 135, or responsive to another portion of the vehicle 100 engaging the object 135 which in turn engages the wheel 805 and causes the wheel 805 to begin to deform.

As depicted in at least FIG. 9, the wheel 805 can include a rim 905 of a tire (e.g., the outermost section of the wheel 805 having the rim 905) and one or more spokes 910 (e.g., the inner metal section that provides structure and support for the tire). The wheel splitting portion 220 (e.g., defined by the protrusion and the inner fillet 310) can be positioned such that the spoke 910 can substantially align with the wheel splitting portion 220 in a front-rear direction of the vehicle 100 (e.g., the L direction) as the wheel 805 moves towards the wheel block 205 (e.g., responsive to a force applied by the object 135 through the wheel 805).

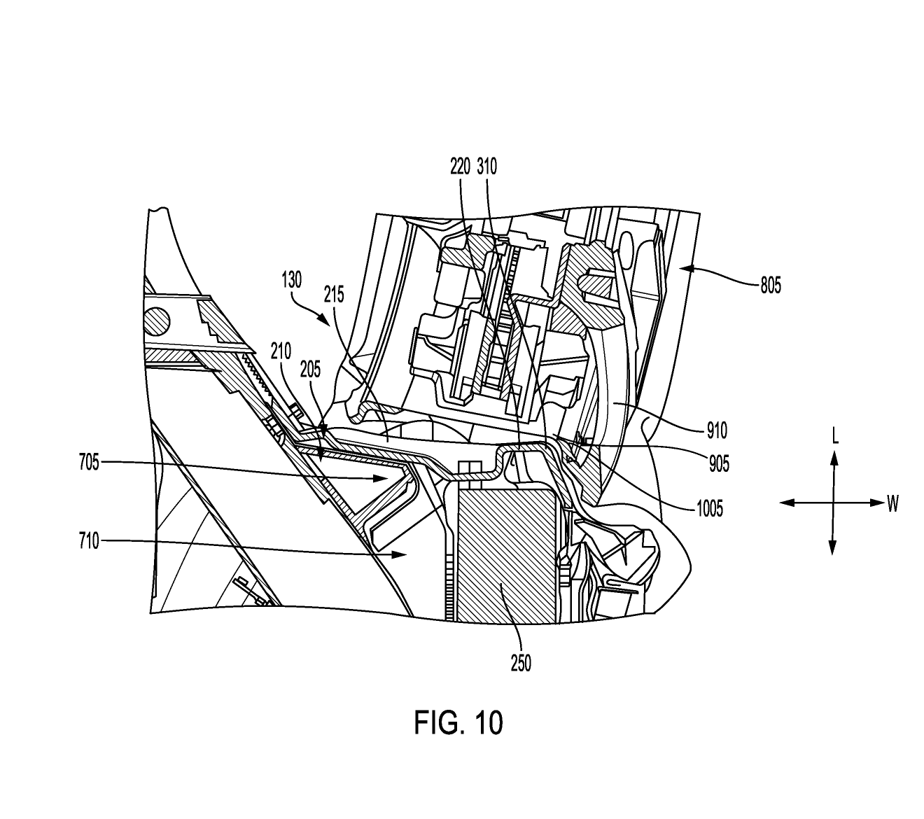

FIG. 10 depicts an example top view of the deflector assembly 130 in a third state. For example, in this state, the deflector assembly 130 can couple with the vehicle 100 (e.g., via fasteners 225, or via other means). In this state, the vehicle 100 can be in motion or stationary. The vehicle 100 can be engaging with (e.g., contacting) the object 135. For example, this state can depict a moment at which the front end 105 of the vehicle 100 continues to contact the object 135 (e.g., within 0-0.05 seconds or more) such that the wheel 805 of the vehicle 100 continues to deform responsive to the wheel 805 engaging with the object 135, or responsive to another portion of the vehicle 100 engaging the object 135 which in turn engages the wheel 805 and causes the wheel 805 to continue to deform.

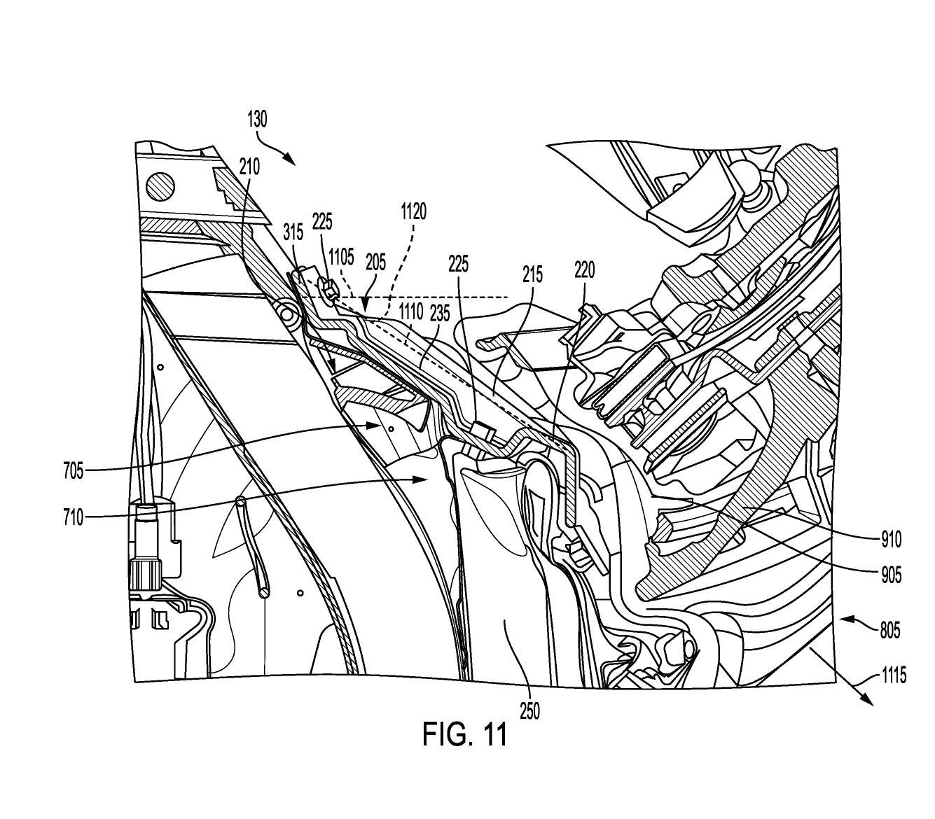

FIG. 11 depicts an example top view of the deflector assembly 130 in a fourth state. For example, in this state, the deflector assembly 130 can couple with the vehicle 100 (e.g., via fasteners 225, or via other means). In this state, the vehicle 100 can be in motion or stationary. The vehicle 100 can be engaging with (e.g., contacting) the object 135. For example, this state can depict a moment at which the front end 105 of the vehicle 100 continues to contact the object 135 (e.g., within 0-0.15 seconds) such that the wheel 805 of the vehicle 100 continues to deform responsive to the wheel 805 engaging with the object 135, or responsive to another portion of the vehicle 100 engaging the object 135 which in turn engages the wheel 805 and causes the wheel 805 to continue to deform.

As depicted in at least FIGS. 10 and 11, as the wheel 805 is pushed further towards the wheel block 205, the wheel splitting portion 220 can engage with (e.g., indirectly contact via contacting the rim 905 of the tire) the spoke 910. The engagement between the wheel splitting portion 220 and the spoke 910 can cause the spoke 910 to separate or split away from a portion of the tire (e.g., the rim 905) such that the spoke 910 is pushed outward away from the vehicle 100 (e.g., as depicted by arrow 1115). For example, the force of the wheel splitting portion 220 against the spoke 910 can cause the spoke 910 to separate or split away from the rim 905 of the tire (e.g., dislocate/pop out the spoke 910 from the rim 905) such that the spoke 910 is pushed outward away from the rocker 250 of the vehicle 100, as depicted in at least FIG. 11. The positioning of the wheel splitting portion 220 (e.g., the fillet 310) facilitates separating the spokes 910 from the rim 905 of the tire. For example, the wheel splitting portion 220 can be disposed in a range of 0 mm – 20 mm from the position 1005 of where the rim and spokes 910 connect at the wheel 805. For example, the wheel splitting portion 220 can be disposed in a range of 0 mm – 10 mm from the position 1005 of where the rim and spokes 910 connect at the wheel 805. For example, the wheel splitting portion 220 can be disposed in a range of 0 mm to 7 mm from the position 1005 of where the rim and spokes 910 connect at the wheel 805.

As the wheel 805 continues to move towards the wheel block 205, the wheel block 205 can deform or pivot (e.g., relative to the fastener 225 that couples the wheel block to the frame at the flanges 315, 730 of the wheel block 205 and torque box 210) from a first position (e.g., shown by first axis 1105) to a second position (e.g., shown by second axis 1110). The pivoting of the wheel block 205 can facilitate causing the ramp portion 215 to guide the wheel 805 (e.g., the rim 905 and the spoke 910) in the direction of the arrow 1115 along the ramp portion 215 of the wheel block 205. For example, the ramp portion 215 can act like slide when the spoke 910 of the wheel 805 separates from the rim such that the ramp portion 215 pushes the wheel 805 away from the rocker 250 in a lateral direction (e.g., W direction).

The wheel block 205 can deform or pivot from the first position (e.g., shown by first axis 1105) to a second position (e.g., shown by second axis 1110) to define an angle 1120 between the first position and the second position. The angle 1120 can facilitate guiding or pushing the wheel 805 away from a proximal portion of the vehicle 100 (e.g., in the direction of arrow 1115). For example, the angle 1120 can be in a range of 5 degrees to 90 degrees, in a range of 15 degrees to 75 degrees, in a range of 25 degrees to 60 degrees, or about 45 degrees. The angle 1120 can include various other ranges including, for example, 0 degrees to 5 degrees, or greater than 90 degrees.

As the wheel 805 continues to move towards the wheel block 205, the torque box 210 can deform. The torque box 210 can provide lateral support for the rocker 250. For example, the shape of the torque box 210 can facilitate guiding or pushing the wheel 805 outward away from the vehicle 100 (e.g., in the direction of arrow 1115). For example, the boomerang-like shape of the torque box 210 coupled with the frame of the vehicle 100 can facilitate cause the torque box 210 to provide additional support for the wheel block 205 as the wheel block 205 pivots and for the rocker 250. For example, the torque box 210 can facilitate maintaining a shape or positioning of the rocker 250 by being disposed adjacent to or directly contacting the rocker 250 in a width-wise direction of the vehicle 100 (e.g., direction W in FIG. 9). With this configuration, the rocker 250 can maintain more of the original shape of the rocker 250 as compared to, for example, the vehicle 100 engaging with the object 135 without the wheel block 205 or the torque box 210. With this configuration, the wheel block 205 and the torque box 210 can facilitate absorbing or redistributing a load of the object 135 (e.g., through the wheel 805) applied to the rocker 250 to reduce a force applied to the rocker 250 as compared to, for example, the vehicle 100 engaging with the object 135 without the wheel block 205 or the torque box 210 and the wheel 805 engaging with the rocker 250 at a more direct angle (e.g., as compared to the deflector assembly 130 pushing the wheel 805 away from the vehicle 100). For example, the deflector assembly 130 can facilitate reducing the load on the rocker 250 to be less than 475 kN when the vehicle 100 engages with the object 135 at approximately 40 mph with the object 135 overlapping about 25% of the front end 105 of the vehicle 100. For example, the deflector assembly 130 can facilitate reducing the load on the rocker 250 to be less than 455 kN when the vehicle 100 engages with the object 135 at approximately 40 mph with the object 135 overlapping about 25% of the front end 105 of the vehicle 100.

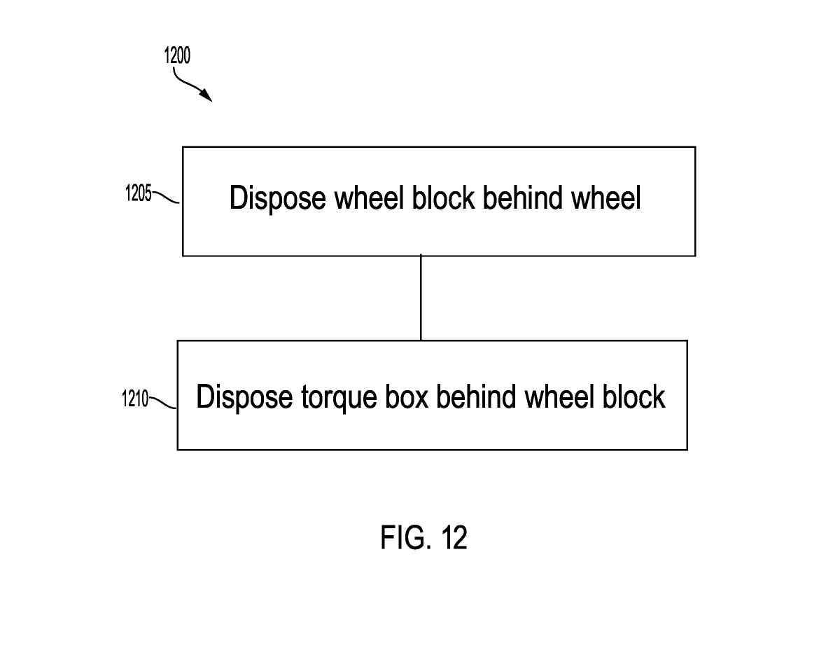

FIG. 12 depicts a method 1200 of operating the deflector assembly 130, according to an example implementation. The method 1200 can include disposing the wheel block 205 behind the wheel 805 of the vehicle 100 in a front-rear direction of the vehicle 100, as depicted in act 1205. For example, the wheel block 205 can couple to a portion of the frame of the vehicle 100 behind the wheel 805.

The method 1200 can include separating, by a portion of the wheel block 205 (e.g., the wheel splitting portion 220) a first portion of the wheel (e.g., the spoke 910) from a second portion of the wheel (e.g., the rim 905) responsive to a frontward force applied to the wheel 805 by, for example, the vehicle 100 engaging with the object 135. For example, the wheel splitting portion 220 can cause the spoke 910 to move away from the rim 905. The method 1200 can include guiding, by a second portion of the wheel block 205 (e.g., the ramp portion 215) the wheel 805 away from the rocker 250. For example, the ramp portion 215 can cause the wheel 805 to move in an outward lateral direction away from the rocker 250 or from the vehicle 100 (e.g., in a direction away from a center of the vehicle 100).

The method 1200 can include disposing the torque box 210 behind the wheel block 205 in the front-rear direction of the vehicle 100, as depicted in act 1210. For example, the torque box 210 can couple to a portion of the vehicle 100 behind the wheel block 205 such that at least a portion of the wheel block 205 covers or overlaps the torque box 210 in the front-rear direction of the vehicle 100. The torque box 210 can couple adjacent to the rocker 250 such that the torque box 210 at least partially engages, or contacts, the rocker 250 in the first state (FIG. 8). For example, the torque box 210 can at least partially overlap the rocker 250 in the width direction (e.g., the lateral direction of the vehicle 100).

The method 1200 can include laterally supporting, by the torque box 210, the rocker 250 disposed adjacent to the torque box 210 responsive to the frontward force applied to the wheel 805. For example, the torque box 210 can deform or move responsive to the force applied to the wheel 805 (e.g., the vehicle contacting the object 135) such that the torque box 210 contacts and pushes the rocker 250 outward from a center of the vehicle 100.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A deflector assembly for a vehicle, the deflector assembly comprising:
a wheel block disposed behind a wheel in a front-rear direction of the vehicle, the wheel block to separate a first portion of the wheel from a second portion of the wheel responsive to a frontward force applied to the wheel; and
a torque box disposed behind the wheel block in the front-rear direction of the vehicle, the torque box to laterally support a rocker disposed adjacent to the torque box responsive to the frontward force applied to the wheel.

2. The deflector assembly of claim 1, comprising:
the wheel block including a ramp portion and a wheel splitting portion;
the wheel splitting portion to separate the first portion of the wheel from the second portion of the wheel responsive to the frontward force applied to the wheel; and
the ramp portion to push the wheel away from the rocker responsive to the frontward force applied to the wheel.

3. The deflector assembly of claim 1, comprising:
the first portion of the wheel including a spoke; and
the second portion of the wheel including a rim.

4. The deflector assembly of claim 1, comprising:
the wheel block including a fillet defining a wheel splitting portion; and
the fillet disposed within a range of 0 mm to 7 mm from a position where the first portion of the wheel connects with the second portion of the wheel when the wheel engages with the wheel splitting portion.

5. The deflector assembly of claim 1, comprising:
the torque box including a first piece coupled with a second piece to define a hollow space; and
the torque box to receive a nylon insert within the hollow space.

6. The deflector assembly of claim 1, comprising:
the wheel block including a monolithic structure including a ramp portion and a wheel splitting portion.

7. The deflector assembly of claim 1, comprising:
the wheel block including three apertures; and
each of the three apertures to receive a fastener to couple the wheel block with a portion of the vehicle.

8. A method, comprising:
disposing a wheel block behind a wheel in a front-rear direction of a vehicle, the wheel block to separate a first portion of the wheel from a second portion of the wheel responsive to a frontward force applied to the wheel; and
disposing a torque box behind the wheel block in the front-rear direction of the vehicle, the torque box to laterally support a rocker disposed adjacent to the torque box responsive to the frontward force applied to the wheel.

9. The method of claim 8, comprising:
the wheel block including a ramp portion and a wheel splitting portion;
the wheel splitting portion to separate the first portion of the wheel from the second portion of the wheel responsive to the frontward force applied to the wheel; and
the ramp portion to push the wheel away from the rocker responsive to the frontward force applied to the wheel.

10. The method of claim 8, comprising:
the first portion of the wheel including a spoke; and
the second portion of the wheel including a rim.

11. The method of claim 8, comprising:
the wheel block including a fillet defining a wheel splitting portion; and
the fillet disposed within a range of 0 mm to 7 mm from a position where the first portion of the wheel connects with the second portion of the wheel when the wheel engages with the wheel splitting portion.

12. The method of claim 8, comprising:
the torque box including a first piece coupled with a second piece to define a hollow space; and
the torque box to receive a nylon insert within the hollow space.

13. The method of claim 8, comprising:
the wheel block including a monolithic structure including a ramp portion and a wheel splitting portion.

14. The method of claim 8, comprising:
the wheel block including three apertures; and
each of the three apertures to receive a fastener to couple the wheel block with a portion of the vehicle.

15. An electric vehicle, comprising:
a deflector assembly, the deflector assembly including:
a wheel block disposed behind a wheel in a front-rear direction of the electric vehicle, the wheel block to separate a first portion of the wheel from a second portion of the wheel responsive to a frontward force applied to the wheel; and
a torque box disposed behind the wheel block in the front-rear direction of the electric vehicle, the torque box to laterally support a rocker disposed adjacent to the torque box responsive to the frontward force applied to the wheel.

16. The electric vehicle of claim 15, comprising:
the wheel block including a ramp portion and a wheel splitting portion;
the wheel splitting portion to separate the first portion of the wheel from the second portion of the wheel responsive to the frontward force applied to the wheel; and
the ramp portion to push the wheel away from the rocker responsive to the frontward force applied to the wheel.

17. The electric vehicle of claim 15, comprising:
the first portion of the wheel including a spoke; and
the second portion of the wheel including a rim.

18. The electric vehicle of claim 15, comprising:
the wheel block including a fillet defining a wheel splitting portion; and
the fillet disposed within a range of 0 mm to 7 mm from a position where the first portion of the wheel connects with the second portion of the wheel when the wheel engages with the wheel splitting portion.

19. The electric vehicle of claim 15, comprising:
the torque box including a first piece coupled with a second piece to define a hollow space; and
the torque box to receive a nylon insert within the hollow space.

20. The electric vehicle of claim 15, comprising:
the wheel block including a monolithic structure including a ramp portion and a wheel splitting portion.
